(19) United States
(12) Patent Application Publication
(10) Pub. No.: US 2023/0093838 A1
(43) Pub. Date: Mar. 30, 2023

(54) ELECTRONIC COMPONENT

(71) Applicant: Murata Manufacturing Co., Ltd., Kyoto-fu (JP)

(72) Inventors: Katsufumi SASAKI, Nagaokakyo-shi (JP); Riku KANEMOTO, Nagaokakyo-shi (JP)

(73) Assignee: Murata Manufacturing Co., Ltd., Kyoto-fu (JP)

(21) Appl. No.: 17/930,629

(22) Filed: Sep. 8, 2022

(30) Foreign Application Priority Data
Sep. 10, 2021 (JP) 2021-147852

(51) Int. Cl. H01F 27/28; H01F 27/24; H01F 27/29

(52) U.S. Cl. CPC H01F 27/2804; H01F 27/24; H01F 27/292; H01F 2027/2809

(57) ABSTRACT

An electronic component comprises a magnetic substrate, a multilayer body including a plurality of insulator layers, and a plurality of coils extending inside the multilayer body. When a first magnetic substrate is viewed toward a third positive direction, an outer edge of the first magnetic substrate includes a linear side. Also, a cutout is recessed inward from the side. When a direction along the side is taken as a first direction and a direction perpendicular to the first direction is taken as a second direction when the first magnetic substrate is viewed toward the third positive direction, a maximum dimension of the cutout in the first direction is different from a maximum dimension of the cutout in the second direction.

### CROSS-REFERENCE TO RELATED APPLICATION

This application claims benefit of priority to Japanese Patent Application No. 2021-147852 filed Sep. 10, 2021, the entire content of which is incorporated herein by reference.

### BACKGROUND

### Technical Field

The present disclosure relates to electronic components.

### Background Art

The electronic component described in Japanese Patent No. 5673837 includes a magnetic substrate and a multilayer body. The magnetic substrate has a substantially rectangular parallelepiped shape having a first main surface and a second main surface parallel to the first main surface. The magnetic substrate includes a plurality of cutouts connecting the first main surface and the second main surface. Each cutout is present on each of four corners of the magnetic substrate. The multilayer body is positioned on the first main surface of the magnetic substrate. The multilayer body is formed of a plurality of insulator layers laminated each other.

Also, the electronic component includes a plurality of coils, a plurality of extended wirings, a plurality of connecting portions, and a plurality of outer electrodes. Each coil extends inside the multilayer body. Each extended wiring connects to an end of each coil. Each extended wiring is partially exposed toward the inside of each cutout. Each connecting portion is present on the inner surface of each cutout. One end of each connecting portion connects to each extended wiring. Each outer electrode is present on the second main surface of the magnetic substrate. Each outer electrode connects to each connecting portion. That is, the outer electrode connects to the coil via the connecting portion and the extended wiring.

### SUMMARY

In the electronic component as described in Japanese Patent No. 5673837, in view of connecting an outer electrode to an extended wiring via a connecting part, as the area of a cutout when the magnetic substrate is viewed toward a direction perpendicular to the first main surface, it is preferable to ensure a large area to some extent. However, since it is required to avoid electrical interference between outer electrodes, it is difficult to simply increase the size of the cutout.

Accordingly, the present disclosure provides an electronic component including a magnetic substrate in a shape having a first main surface and a second main surface parallel to the first main surface. The magnetic substrate has a plurality of cutouts connecting the first main surface and the second main surface together. The electronic component also includes a multilayer body formed of a plurality of insulator layers laminated on the first main surface; a plurality of coils extending inside the multilayer body; an extended wiring connecting to an end of any of the coils and partially exposed inside any of the cutouts; a connecting portion which is present on an inner surface of the cutout and connects to the extended wiring; and an outer electrode which is present on the second main surface and connects to the connecting portion. When the magnetic substrate is viewed toward a direction perpendicular to the first main surface, an outer edge of the magnetic substrate includes a linear first side, and at least one of the plurality of cutouts is recessed inward from the first side. When the magnetic substrate is viewed toward the direction perpendicular to the first main surface and when a direction along the first side is taken as a first direction and a direction perpendicular to the first direction is taken as a second direction, a maximum dimension of the cutout in the first direction is different from a maximum dimension of the cutout in the second direction.

According to the above-described structure, the maximum dimension of the cutout in the first direction is intentionally made different from the maximum dimension of the cutout in the second direction. Therefore, a design can be made in which electrical interference between the outer electrodes and so forth are suppressed while a sufficient area is ensured as the area of each cutout when the magnetic substrate is viewed toward the direction perpendicular to the first main surface.

Design flexibility can be improved, while a sufficient area is ensured as the area of each cutout.

### BRIEF DESCRIPTION OF THE DRAWINGS

FIG. 1 is a perspective view of an electronic component of Embodiment 1;

FIG. 2 is a perspective view of the electronic component of Embodiment 1;

FIG. 3 is an exploded perspective view of the electronic component of Embodiment 1;

FIG. 4 is a bottom view of the electronic component of Embodiment 1;

FIG. 5 is a perspective view of an electronic component of Embodiment 2;

FIG. 6 is a bottom view of the electronic component of Embodiment 2;

FIG. 7 is a bottom view of an electronic component of Embodiment 3;

FIG. 8 is a bottom view of a multilayer body of the electronic component of Embodiment 3;

FIG. 9 is a bottom view of an electronic component of a modification;

FIG. 10 is a bottom view of an electronic component of another modification;

FIG. 11 is a bottom view of an electronic component of still another modification; and

FIG. 12 is a bottom view of an electronic component of yet another modification.

### DETAILED DESCRIPTION

### Embodiment 1

Embodiment 1 of an electronic component is described below. Note that, in the drawings, components may be depicted as enlarged for the purpose of easy understanding. The dimensional ratio of each component may be different from the actual dimensional ratio or the dimensional ratio in another drawing.

### Regarding Overall Structure

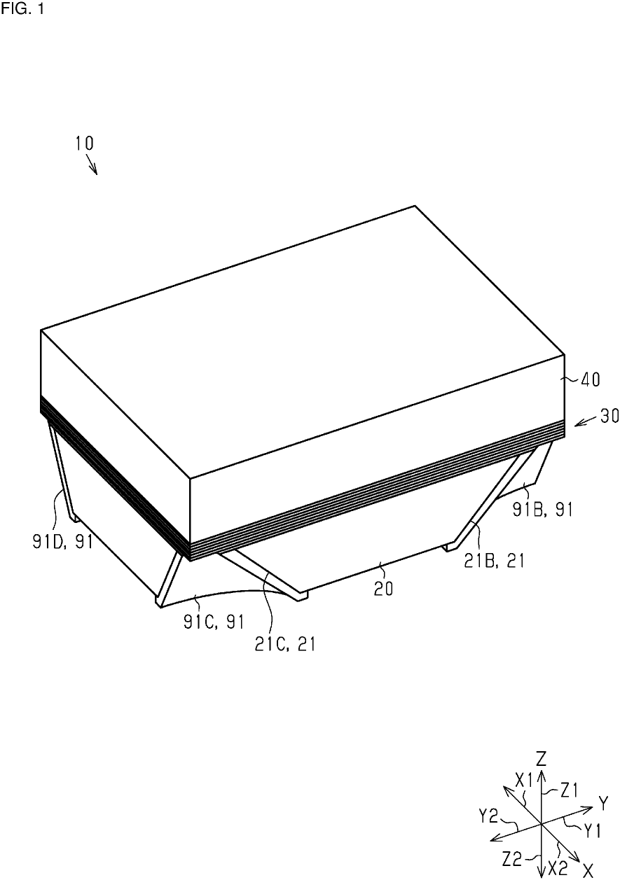

As depicted in FIG. 1, an electronic component 10 includes a first magnetic substrate 20, a multilayer body 30, and a second magnetic substrate 40.

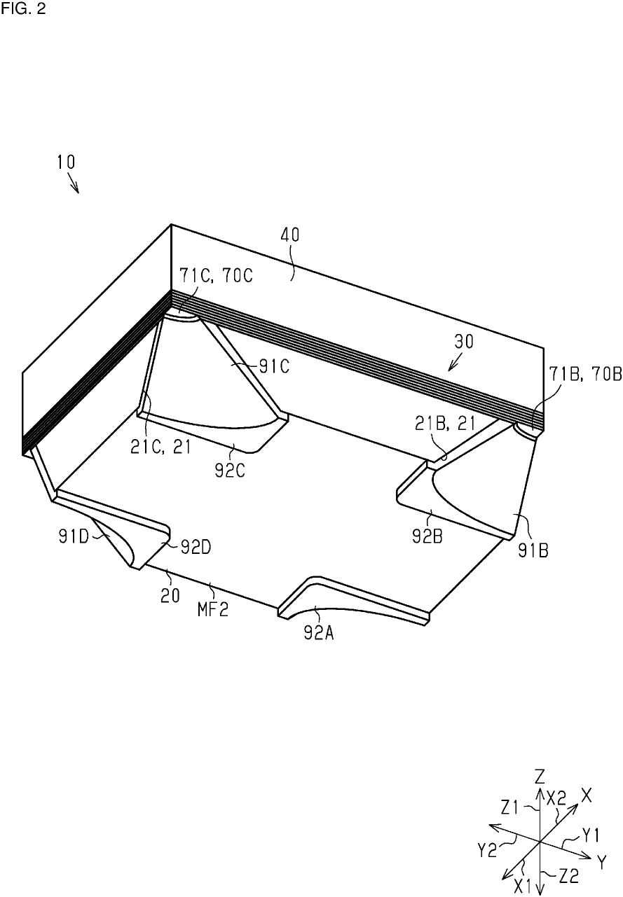

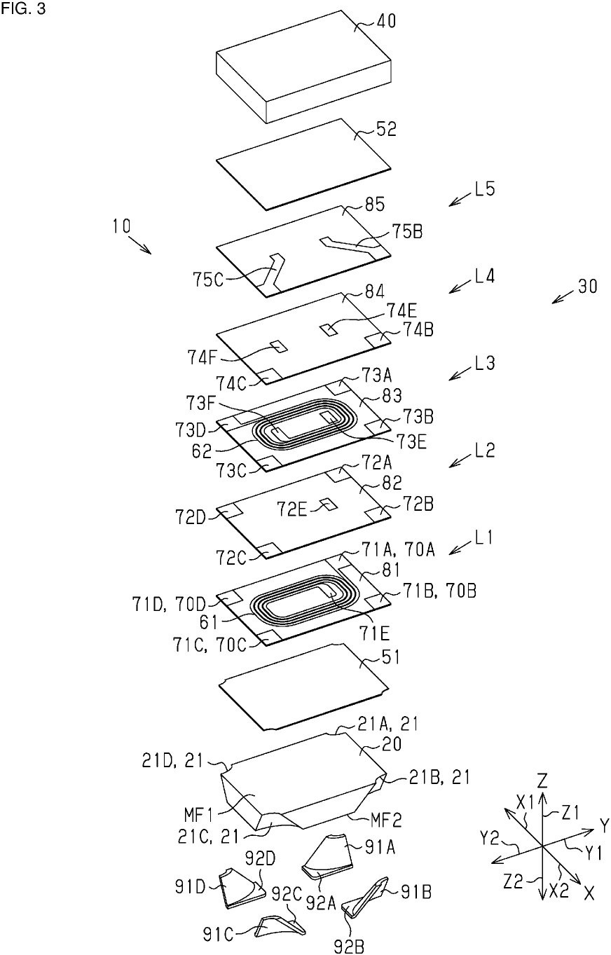

As depicted in FIG. 3, the first magnetic substrate 20 has a substantially rectangular parallelepiped shape. The first magnetic substrate 20 has a first main surface MF1. The first main surface MF1 is a surface having the largest area among surfaces configuring outer surfaces of the first magnetic substrate 20. Also, as depicted in FIG. 2, the first magnetic substrate 20 has a second main surface MF2. The second main surface MF2 is parallel to the first main surface MF1.

When the first magnetic substrate 20 is viewed toward a direction perpendicular to the first main surface MF1, the first magnetic substrate 20 has a substantially rectangular shape with four corners cut out, and has four linear sides. In the description below, as depicted in FIG. 3, when the first magnetic substrate 20 is viewed toward the direction perpendicular to the first main surface MF1, an axis parallel to a specific one side among the four sides is taken as a first axis X. Also, when the first magnetic substrate 20 is viewed toward the direction perpendicular to the first main surface MF1, an axis perpendicular to the first axis X is taken as a second axis Y. Furthermore, an axis perpendicular to the first main surface MF1 is taken as a third axis Z. Also, one direction parallel to the first axis X is taken as a first positive direction X1, and a direction opposite to the first positive direction X1 among directions along the first axis X is taken as a first negative direction X2. Also, one direction along the second axis Y is taken as a second positive direction Y1, and a direction opposite to the second positive direction Y1 among directions along the second axis Y is taken as a second negative direction Y2. Furthermore, a direction to which the first main surface MF1 is oriented among directions along the third axis Z is taken as a third positive direction Z1, and a direction opposite to the third positive direction Z1 is taken as a third negative direction Z2.

The dimension of the first magnetic substrate 20 in the direction along the second axis Y is larger than the dimension of the first magnetic substrate 20 in the direction along the first axis X. That is, the first main surface MF1 and the second main surface MF2 of the first magnetic substrate 20 each have a rectangular shape elongated to a direction along the second axis Y as a whole. The first magnetic substrate 20 is made of a magnetic substance. The magnetic substance is, for example, a ferrite-ceramic sintered body.

As depicted in FIG. 3, the first magnetic substrate 20 includes four cutouts 21A to 21D connecting the first main surface MF1 and the second main surface MF2 together. Each cutout 21 is present at each of four corners when the first magnetic substrate 20 is viewed toward the third positive direction Z1. That is, each cutout 21 is a space that is present at each of four corners of the first magnetic substrate 20. Also, the area of each cutout 21 when the first magnetic substrate 20 is viewed toward the third positive direction Z1 is smaller as closer to the first main surface MF1 from the second main surface MF2. Note that the four cutouts 21A to 21D are referred to below as cutouts 21 when a distinction is not made among them.

The cutout 21A is positioned at a corner on a first positive direction X1 side and a second positive direction Y1 side when viewed from the center of the first magnetic substrate 20. The cutout 21B is positioned at a corner on a first negative direction X2 side and a second positive direction Y1 side when viewed from the center of the first magnetic substrate 20. The cutout 21C is positioned at a corner on a first negative direction X2 side and a second negative direction Y2 side when viewed from the center of the first magnetic substrate 20. The cutout 21D is positioned at a corner on a first positive direction X1 side and a second negative direction Y2 side when viewed from the center of the first magnetic substrate 20.

The electronic component 10 includes a first adhesive layer 51. The first adhesive layer 51 is made of an organic adhesive such as polyimide resin. When the first adhesive layer 51 is viewed toward the third negative direction Z2, the first adhesive layer 51 covers the entire first main surface MF1 of the first magnetic substrate 20.

As depicted in FIG. 1, the multilayer body 30 has a rectangular parallelepiped shape. As depicted in FIG. 3, the multilayer body 30 is laminated on the first main surface MF1 of the first magnetic substrate 20 via the first adhesive layer 51. Thus, the multilayer body 30 is bonded to the first magnetic substrate 20 by the first adhesive layer 51.

As depicted in FIG. 3, the multilayer body 30 has a first layer L1 to a fifth layer L5. The first layer L1 to the fifth layer L5 each have a substantially same thickness, that is, a substantially same dimension in a direction along the third axis Z. Also, the main surface of each layer is parallel to the first main surface MF1 of the first magnetic substrate 20.

The first layer L1 includes a first coil 61, five extended portions 71A to 71E, and a first insulator layer 81. The extended portion 71A is positioned at a corner on a first positive direction X1 side and a second positive direction Y1 side when viewed from the center of the first layer L1. The extended portion 71B is positioned at a corner on a first negative direction X2 side and a second positive direction Y1 side when viewed from the center of the first layer L1. The extended portion 71C is positioned at a corner on a first negative direction X2 side and a second negative direction Y2 side when viewed from the center of the first layer L1. The extended portion 71D is positioned at a corner on a first positive direction X1 side and a second negative direction Y2 side when viewed from the center of the first layer L1. The extended portion 71E is positioned on a second positive direction Y1 side when viewed from the center of the first layer L1 and at the center in a direction along the first axis X. The extended portion 71A to the extended portion 71E are made of a conductive material such as copper or silver. In the present embodiment, the extended portion 71A to the extended portion 71E are made of the same conductive material as that of the first coil 61.

When the first layer L1 is viewed toward the third negative direction Z2, the first coil 61 extends in a spiral shape as a whole, taking the center of the first layer L1 as a center. A first end of the first coil 61 connects to the extended portion 71A. A second end of the first coil 61 connects to the extended portion 71E. When the first layer L1 is viewed toward the third negative direction Z2, the first coil 61 winds as proceeding clockwise from the first end to the second end. The first coil 61 is made of a conductive material such as copper or silver. In the present embodiment, the first coil 61 is made of the same conductive material as that of the extended portion 71A to the extended portion 71E.

In the first layer L1, a portion except the first coil 61 and the extended portion 71A to the extended portion 71E is the first insulator layer 81. The first insulator layer 81 is made of a non-magnetic insulator such as glass, resin, or alumina. In the present embodiment, the first insulator layer 81 is made of polyimide resin, which is the same material as that of the first adhesive layer 51.

The second layer L2 includes five extended portions 72A to 72E and a second insulator layer 82.

The extended portion 72A is positioned at a corner on a first positive direction X1 side and a second positive direction Y1 side when viewed from the center of the second layer L2. Thus, the extended portion 72A is laminated on a surface of the extended portion 71A of the first layer L1 oriented to the third positive direction Z1.

The extended portion 72B is positioned at a corner on a first negative direction X2 side and a second positive direction Y1 side when viewed from the center of the second layer L2. Thus, the extended portion 72B is laminated on a surface of the extended portion 71B of the first layer L1 oriented to the third positive direction Z1.

The extended portion 72C is positioned at a corner on a first negative direction X2 side and a second negative direction Y2 side when viewed from the center of the second layer L2. Thus, the extended portion 72C is laminated on a surface of the extended portion 71C of the first layer L1 oriented to the third positive direction Z1.

The extended portion 72D is positioned at a corner on a first positive direction X1 side and a second negative direction Y2 side when viewed from the center of the second layer L2. Thus, the extended portion 72D is laminated on a surface of the extended portion 71D of the first layer L1 oriented to the third positive direction Z1.

The extended portion 72E is positioned on a second positive direction Y1 side when viewed from the center of the second layer L2 and at the center in a direction along the first axis X. That is, the extended portion 72E of the second layer L2 is positioned at the same location as that of the extended portion 71E of the first layer L1 when the multilayer body 30 is viewed toward the third negative direction Z2. Thus, the extended portion 72E is laminated on a surface of the extended portion 71E of the first layer L1 oriented to the third positive direction Z1. The extended portion 72A to the extended portion 72E are made of a conductive material such as copper or silver. In the present embodiment, the extended portion 72A to the extended portion 72E are made of the same conductive material as that of the first coil 61.

In the second layer L2, a portion except the extended portion 72A to the extended portion 72E is the second insulator layer 82. The second insulator layer 82 is made of a non-magnetic insulator such as glass, resin, or alumina. In the present embodiment, the second insulator layer 82 is made of the same insulator material as that of the first insulator layer 81.

The third layer L3 includes a second coil 62, six extended portions 73A to 73F, and a third insulator layer 83. The extended portion 73A is positioned at a corner on a first positive direction X1 side and a second positive direction Y1 side when viewed from the center of the third layer L3. Thus, the extended portion 73A is laminated on a surface of the extended portion 72A of the second layer L2 oriented to the third positive direction Z1.

The extended portion 73B is positioned at a corner on a first negative direction X2 side and a second positive direction Y1 side when viewed from the center of the third layer L3. Thus, the extended portion 73B is laminated on a surface of the extended portion 72B of the second layer L2 oriented to the third positive direction Z1.

The extended portion 73C is positioned at a corner on a first negative direction X2 side and a second negative direction Y2 side when viewed from the center of the third layer L3. Thus, the extended portion 73C is laminated on a surface of the extended portion 72C of the second layer L2 oriented to the third positive direction Z1.

The extended portion 73D is positioned at a corner on a first positive direction X1 side and a second negative direction Y2 side when viewed from the center of the third layer L3. Thus, the extended portion 73D is laminated on a surface of the extended portion 72D of the second layer L2 oriented to the third positive direction Z1.

The extended portion 73E is positioned on a second positive direction Y1 side when viewed from the center of the third layer L3 and at the center in a direction along the first axis X. That is, the extended portion 73E of the third layer L3 is positioned at the same location as that of the extended portion 72E of the second layer L2 when the multilayer body 30 is viewed toward the third negative direction Z2. Thus, the extended portion 73E is laminated on a surface of the extended portion 72E of the second layer L2 oriented to the third positive direction Z1.

The extended portion 73F is positioned on a second negative direction Y2 side when viewed from the center of the third layer L3 and at the center in a direction along the first axis X. The extended portion 73A to the extended portion 73F are made of a conductive material such as copper or silver. In the present embodiment, the extended portion 73A to the extended portion 73F are made of the same conductive material as that of the first coil 61.

When the third layer L3 is viewed toward the third negative direction Z2, the second coil 62 extends in a spiral shape as a whole, taking the center of the third layer L3 as a center. A first end of the second coil 62 connects to the extended portion 73D. A second end of the second coil 62 connects to the extended portion 73F. When the third layer L3 is viewed toward the third negative direction Z2, the second coil 62 winds as proceeding clockwise from the first end to the second end. Also, the second coil 62 is positioned on a third positive direction Z1 side when viewed from the first coil 61. Thus, the second coil 62 and the first coil 61 configure a common mode choke coil. The second coil 62 is made of a conductive material such as copper or silver. In the present embodiment, the second coil 62 is made of the same conductive material as that of the first coil 61.

In the third layer L3, a portion except the second coil 62 and the extended portion 73A to the extended portion 73F is the third insulator layer 83. The third insulator layer 83 is made of a non-magnetic insulator such as glass, resin, or alumina. In the present embodiment, the third insulator layer 83 is made of the same insulator material as that of the first insulator layer 81.

The fourth layer L4 includes an extended portion 74B, an extended portion 74C, an extended portion 74E, an extended portion 74F, and a fourth insulator layer 84.

The extended portion 74B is positioned at a corner on a first negative direction X2 side and a second positive direction Y1 side when viewed from the center of the fourth layer L4. Thus, the extended portion 74B is laminated on a surface of the extended portion 73B of the third layer L3 oriented to the third positive direction Z1.

The extended portion 74C is positioned at a corner on a first negative direction X2 side and a second negative direction Y2 side when viewed from the center of the fourth layer L4. Thus, the extended portion 74C is laminated on a surface of the extended portion 73C of the third layer L3 oriented to the third positive direction Z1.

The extended portion 74E is positioned on a second positive direction Y1 side when viewed from the center of the fourth layer L4 and at the center in a direction along the first axis X. That is, the extended portion 74E of the fourth layer L4 is positioned at the same location as that of the extended portion 73E of the third layer L3 when the multilayer body 30 is viewed toward the third negative direction Z2. Thus, the extended portion 74E is laminated on a surface of the extended portion 73E of the third layer L3 oriented to the third positive direction Z1.

The extended portion 74F is positioned on a second negative direction Y2 side when viewed from the center of the fourth layer L4 and at the center in a direction along the first axis X. That is, the extended portion 74F of the fourth layer L4 is positioned at the same location as that of the extended portion 73F of the third layer L3 when the multilayer body 30 is viewed toward the third negative direction Z2. Thus, the extended portion 74F is laminated on a surface of the extended portion 73F of the third layer L3 oriented to the third positive direction Z1. The extended portion 74B to the extended portion 74F are made of a conductive material such as copper or silver. In the present embodiment, the extended portion 74B to the extended portion 74F are made of the same conductive material as that of the first coil 61.

In the fourth layer L4, a portion except the extended portion 74B to the extended portion 74F is the fourth insulator layer 84. The fourth insulator layer 84 is made of a non-magnetic insulator such as glass, resin, or alumina. In the present embodiment, the fourth insulator layer 84 is made of the same insulator material as that of the first insulator layer 81.

The fifth layer L5 includes an extended portion 75B, an extended portion 75C, and a fifth insulator layer 85.

When the fifth layer L5 is viewed toward the third negative direction Z2, the extended portion 75B extends from a portion where the extended portion 74B of the fourth layer L4 overlaps to a portion where the extended portion 74E of the fourth layer L4 overlaps.

When the fifth layer L5 is viewed toward the third negative direction Z2, the extended portion 75C extends from a portion where the extended portion 74C of the fourth layer L4 overlaps to a portion where the extended portion 74F of the fourth layer L4 overlaps.

In the fifth layer L5, a portion except the extended portion 75B and the extended portion 75C is the fifth insulator layer 85. The fifth insulator layer 85 is made of a non-magnetic insulator such as glass, resin, or alumina. In the present embodiment, the fifth insulator layer 85 is made of the same insulator material as that of the first insulator layer 81.

Since the above-described first layer L1 to fifth layer L5 are laminated, the multilayer body 30 formed of the plurality of the first insulator layer 81 to the fifth insulator layer 85 is configured. Also, the first coil 61 and the second coil 62 extend inside the multilayer body 30.

Also, a first extended wiring 70A is configured of the above-described extended portion 71A, extended portion 72A, and extended portion 73A. The first extended wiring 70A connects to the first end of the first coil 61. Also, of the first extended wiring 70A, a surface of the extended portion 71A oriented to the third negative direction Z2 is exposed outside the multilayer body 30 and the first adhesive layer 51.

A second extended wiring 70B is configured of the above-described extended portion 71E, extended portion 72E, extended portion 73E, extended portion 74E, extended portion 75B, extended portion 74B, extended portion 73B, extended portion 72B, and extended portion 71B. The second extended wiring 70B connects to the second end of the first coil 61. Also, of the second extended wiring 70B, a surface of the extended portion 71B oriented to the third negative direction Z2 is exposed outside the multilayer body 30 and the first adhesive layer 51.

A fourth extended wiring 70D is configured of the above-described extended portion 71D, extended portion 72D, and extended portion 73D. The fourth extended wiring 70D connects to the first end of the second coil 62. Also, of the fourth extended wiring 70D, a surface of the extended portion 71D oriented to the third negative direction Z2 is exposed outside the multilayer body 30 and the first adhesive layer 51.

A third extended wiring 70C is configured of the above-described extended portion 73F, extended portion 74F, extended portion 75C, extended portion 74C, extended portion 73C, extended portion 72C, and extended portion 71C. The third extended wiring 70C connects to the second end of the second coil 62. Also, of the third extended wiring 70C, a surface of the extended portion 71C oriented to the third negative direction Z2 is exposed outside the multilayer body 30 and the first adhesive layer 51.

The electronic component 10 includes a second adhesive layer 52. The second adhesive layer 52 is made of an organic adhesive such as polyimide resin. When the second adhesive layer 52 is viewed toward the third negative direction Z2, the second adhesive layer 52 covers the entire surface of the multilayer body 30 oriented to the third positive direction Z1.

The second magnetic substrate 40 has a rectangular parallelepiped shape. The second magnetic substrate 40 is made of a magnetic substance. The magnetic substance is, for example, a ferrite-ceramic sintered body. In the present embodiment, the second magnetic substrate 40 is made of the same magnetic substance as that of the first magnetic substrate 20.

The electronic component 10 includes four connecting portions 91A to 91D and four outer electrodes 92A to 92D.

The connecting portion 91A is positioned on an inner surface of the cutout 21A. The connecting portion 91A is present over the entire inner surface of the cutout 21A. The connecting portion 91B is positioned on an inner surface of the cutout 21B. The connecting portion 91B is present over the entire inner surface of the cutout 21B. The connecting portion 91C is positioned on an inner surface of the cutout 21C. The connecting portion 91C is present over the entire inner surface of the cutout 21C. The connecting portion 91D is positioned on an inner surface of the cutout 21D. The connecting portion 91D is present over the entire inner surface of the cutout 21D. These connecting portions 91A to 91D are made of a conductor containing copper as a main component. Note that the plurality of connecting portions 91A to 91D are referred to below as connecting portions 91 when a distinction is not made among them.

Since the connecting portion 91A is present over the entire inner surface of the cutout 21A, the connecting portion 91A and the first extended wiring 70A exposed outside the multilayer body 30 and the first adhesive layer 51 connect together. Similarly, since the connecting portion 91B is present over the entire inner surface of the cutout 21B, the connecting portion 91B and the second extended wiring 70B exposed outside the multilayer body 30 and the first adhesive layer 51 connect together. Since the connecting portion 91C is present over the entire inner surface of the cutout 21C, the connecting portion 91C and the third extended wiring 70C exposed outside the multilayer body 30 and the first adhesive layer 51 connect together. Since the connecting portion 91D is present over the entire inner surface of the cutout 21D, the connecting portion 91D and the fourth extended wiring 70D exposed outside the multilayer body 30 and the first adhesive layer 51 connect together.

The outer electrode 92A is present on the second main surface MF2 and connects to the connecting portion 91A. The outer electrode 92B is present on the second main surface MF2 and connects to the connecting portion 91B. The outer electrode 92C is present on the second main surface MF2 and connects to the connecting portion 91C. The outer electrode 92D is present on the second main surface MF2 and connects to the connecting portion 91D. The outer electrodes 92A to 92D do not connect to one another.

In this manner, the outer electrode 92A connects to the first coil 61 via the connecting portion 91A and the first extended wiring 70A. The outer electrode 92B connects to the first coil 61 via the connecting portion 91B and the second extended wiring 70B. The outer electrode 92C connects to the second coil 62 via the connecting portion 91C and the third extended wiring 70C. The outer electrode 92D connects to the second coil 62 via the connecting portion 91D and the fourth extended wiring 70D.

The outer electrodes 92A to 92D are made of a conductor containing copper as a main component. In the present embodiment, the outer electrodes 92A to 92D are made of the same conductor material as that of the connecting portions 91A to 91D.

### Regarding Dimensional Relation Among Cutouts

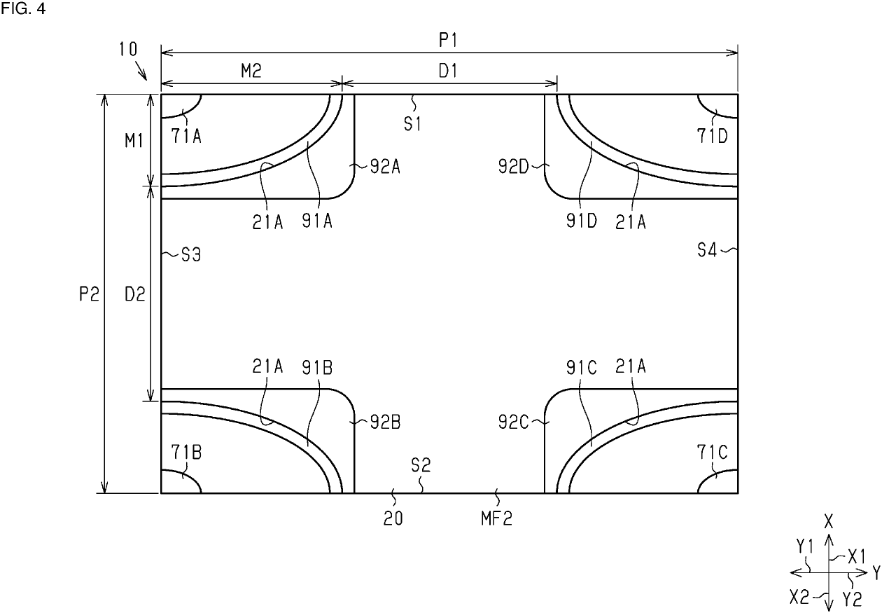

As depicted in FIG. 4, when the first magnetic substrate 20 is viewed toward the third positive direction Z1, the outer edge of the first magnetic substrate 20 includes four linear sides S1 to S4.

The side S1 is a linear side extending to a direction along the second axis Y. The side S1 is positioned on a first positive direction X1 side when viewed from the center of the first magnetic substrate 20. The side S2 is a linear side extending to the direction along the second axis Y. The side S2 is positioned on a first negative direction X2 side when viewed from the center of the first magnetic substrate 20. The side S3 is a linear side extending to a direction along the first axis X. The side S3 is positioned on a second positive direction Y1 side when viewed from the center of the first magnetic substrate 20. The side S3 is adjacent to the side S1 across the cutout 21A. Also, the side S3 is adjacent to the side S2 across the cutout 21B. The side S4 is a linear side extending to the direction along the first axis X. The side S4 is positioned on a second negative direction Y2 side when viewed from the center of the first magnetic substrate 20. The side S4 is adjacent to the side S2 across the cutout 21C. Also, the side S4 is adjacent to the side S1 across the cutout 21D. Note that “adjacent” does not necessarily mean “directly connected” but includes “adjacent across the cutout 21” as described above.

Here, when the first magnetic substrate 20 is viewed toward the third positive direction Z1, the cutout 21A is recessed inward from the side S1 and the side S3. That is, the cutout 21A is recessed from the side S1 to a first negative direction X2 side and from the side S3 to a second negative direction Y2 side. When the first magnetic substrate 20 is viewed toward the third positive direction Z1, the cutout 21B is recessed inward from the side S2 and the side S3. That is, the cutout 21B is recessed from the side S2 to a first positive direction X1 side and from the side S3 to a second negative direction Y2 side. When the first magnetic substrate 20 is viewed toward the third positive direction Z1, the cutout 21C is recessed inward from the side S2 and the side S4. That is, the cutout 21C is recessed from the side S2 to a first positive direction X1 side and from the side S4 to a second positive direction Y1 side. When the first magnetic substrate 20 is viewed toward the third positive direction Z1, the cutout 21D is recessed inward from the side S1 and the side S4. That is, the cutout 21D is recessed from the side S1 to a first negative direction X2 side and from the side S4 to a second positive direction Y1 side. Note that the contour of each cutout 21 on the second main surface MF2 is indicated by a solid line in FIG. 4. In the following, the same goes for the bottom views of the electronic component.

Also, when the first magnetic substrate 20 is viewed toward the third positive direction Z1, a maximum dimension of the cutout 21A in a direction perpendicular to a direction along the side S1, that is, a direction along the first axis X, is taken as a first dimension M1. Also, when the first magnetic substrate 20 is viewed toward the third positive direction Z1, a maximum dimension of the cutout 21A in a direction along the side S1, that is, a direction along the second axis Y, is taken as a second dimension M2. Here, the first dimension M1 is different from the second dimension M2. Specifically, the second dimension M2 is larger than the first dimension M1. In this case, when the side S1 is taken as a first side, a first direction is the direction along the second axis Y, a second side is the side S3, and a second direction is the direction along the first axis X. Note that the dimension of each cutout 21 is a dimension on the same plane as the second main surface MF2. Thus, in the present embodiment, the dimension of each cutout 21 is a dimension on the outer edge of the first magnetic substrate 20 when the first magnetic substrate 20 is viewed toward the third positive direction Z1. Specifically, with reference to a point of intersection of extension lines obtained by extending the side S1 to the second positive direction Y1 and the side S3 to the first positive direction X1, a distance from the point of intersection to the side S1 is taken as the second dimension M2. Also, a distance from the point of intersection to the side S3 is taken as the first dimension M1.

Also, when the first magnetic substrate 20 is viewed toward the third positive direction Z1, a maximum dimension of the cutout 21B in a direction along the side S1, that is, a direction along the second axis Y, is larger than a maximum dimension of the cutout 21B in a direction perpendicular to a direction along the side S1, that is, a direction along the first axis X.

Also, when the first magnetic substrate 20 is viewed toward the third positive direction Z1, a maximum dimension of the cutout 21C in a direction along the side S1, that is, a direction along the second axis Y, is larger than a maximum dimension of the cutout 21C in a direction perpendicular to a direction along the side S1, that is, a direction along the first axis X.

Also, when the first magnetic substrate 20 is viewed toward the third positive direction Z1, a maximum dimension of the cutout 21D in a direction along the side S1, that is, a direction along the second axis Y, is larger than a maximum dimension of the cutout 21D in a direction perpendicular to a direction along the side S1, that is, a direction along the first axis X.

When the first magnetic substrate 20 is viewed toward the third positive direction Z1, the second dimension M2 is equal to a maximum dimension of each of the cutouts 21B to 21D in a direction along the second axis Y. Also, when the first magnetic substrate 20 is viewed toward the third positive direction Z1, the first dimension M1 is equal to a maximum dimension of each of the cutouts 21B to 21D in a direction along the first axis X. Also, when the first magnetic substrate 20 is viewed toward the third positive direction Z1, the shape of the cutout 21A is a shape obtained by cutting out an oval into four pieces along the major axis and the minor axis. The shape of the cutout 21A is identical to the shape of each of the cutouts 21B to 21D. Thus, when the first magnetic substrate 20 is viewed toward the third positive direction Z1, all of the cutouts 21 have an equal area.

Also, on the side S1, two cutouts 21, that is, the cutout 21A and the cutout 21D are present. On the side S3, two cutouts 21, that is, the cutout 21A and the cutout 21B are present.

Here, when the first magnetic substrate 20 is viewed toward the third positive direction Z1, the first magnetic substrate 20 has a rectangular shape elongated to a direction along the second axis Y as a whole. Thus, the dimension of the first magnetic substrate 20 in a direction along the side S1 is larger than the dimension of the first magnetic substrate 20 in a direction along the side S3. The dimension of the first magnetic substrate 20 in the direction along the side S1 is the maximum dimension of the first magnetic substrate 20 in the direction along the second axis Y. Also, the dimension of the first magnetic substrate 20 in a direction along the side S3 is the maximum dimension of the first magnetic substrate 20 in the direction along the first axis X. Also, a value obtained by dividing the dimension of the first magnetic substrate 20 in the direction along the side S1 by a number obtained by subtracting 1 from the number of cutouts 21 present on the side S1, that is, 2, is taken as a first side pitch P1. Also, a value obtained by dividing the dimension of the first magnetic substrate 20 in the direction along the side S3 by a number obtained by subtracting 1 from the number of cutouts 21 present on the side S3, that is, 2, is taken as a second side pitch P2. In this case, the first side pitch P1 is larger than the second side pitch P2. That is, the pitch between the cutouts 21 present on the side S1 is larger than the pitch between the cutouts 21 present on the side S3.

As described above, the number of cutouts 21 present on the side S1 and the number of cutouts 21 present on the side S3 are equal. Here, when the first magnetic substrate 20 is viewed toward the third positive direction Z1, a shortest distance between adjacent two cutouts 21 on the outer edge of the first magnetic substrate 20 is taken as an inter-cutout distance. In this case, an inter-cutout distance D1 in a direction along the side S1 is equal to an inter-cutout distance D2 in a direction along the side S3.

### Regarding Operation and Effects of Embodiment 1

It is assumed that, when the first magnetic substrate 20 is viewed toward the third positive direction Z1, a maximum dimension of the cutout 21A in the direction along the side S1, that is, the direction along the second axis Y, is equal to a maximum dimension of the cutout 21A in a direction perpendicular to the direction along the side S1, that is, the direction along the first axis X. In this case, if the area of each cutout 21 is simply increased, the distance between the cutouts 21 in the direction along the first axis X is shortened. On the other hand, if the distance between the cutouts 21 in the direction along the first axis X is ensured, it is difficult to ensure the area of each cutout 21.

(1-1) According to Embodiment 1 described above, the second dimension M2 is larger than the first dimension M1. Thus, since the dimensions of the cutout 21 are varied, the area of each cutout 21 can be ensured while the distance between the cutouts 21 in the direction along the first axis X is ensured.

Thus, according to Embodiment 1 described above, the second dimension M2 is intentionally made different from the first dimension M1. Therefore, a design can be made in which electrical interference between the outer electrodes 92A to 92D and so forth are suppressed while a sufficient area is ensured as the area of each cutout 21 when the first magnetic substrate 20 is viewed toward the third positive direction Z1.

(1-2) According to Embodiment 1 described above, the first side pitch P1 is larger than the second side pitch P2. Furthermore, each cutout 21 is designed to be elongated to the direction along the second axis Y, that is, a direction in which the larger-pitch side S1 extends. Thus, the dimension of the cutout 21 in the direction along the first axis X, that is, a direction in which the smaller-pitch side S3 extends, can be made relatively small. Thus, the distance between the cutouts 21 in the direction along the first axis X can be easily ensured. As a result, electrical interference of the outer electrodes 92A to 92D and so forth can be easily suppressed.

(1-3) According to Embodiment 1 described above, the inter-cutout distance D1 in the direction along the first axis X and the inter-cutout distance D2 in the direction along the second axis Y are equal. Thus, electrical interference of the outer electrodes 92A to 92D are easily prevented at the same level in both directions. Also, each cutout range of the second main surface MF2 has an amount at the same level in both directions. Thus, when the electronic component 10 is mounted on a substrate, the electronic component 10 less tends to be tilted, and the orientation of the electronic component 10 is stabilized.

(1-4) According to Embodiment 1 described above, when the first magnetic substrate 20 is viewed toward the third positive direction Z1, all of the cutouts 21 have an equal area. Thus, when the electronic component 10 is mounted on a substrate, a substantially same amount of solder is attached to each of the four corners of the first magnetic substrate 20. Thus, the electronic component 10 can be prevented from being mounted on the substrate as being tilted due to varied amounts of solder.

(1-5) According to Embodiment 1 described above, when the first magnetic substrate 20 is viewed toward the third positive direction Z1, each cutout 21 has a shape obtained by partially cutting out an oval. Compared with a case in which the cutout 21 has a quadrature shape or the like, it is not required to process the corners. Thus, the cutouts 21 can be easily formed.

### Embodiment 2

Embodiment 2 of the electronic component is described below with reference to the drawings. An electronic component 110 of Embodiment 2 is different from the electronic component 10 of Embodiment 1 mainly in the number of cutouts 121. Note that description is made below mainly on points different from the electronic component 10 in Embodiment 1 and description on the same points is simplified or omitted.

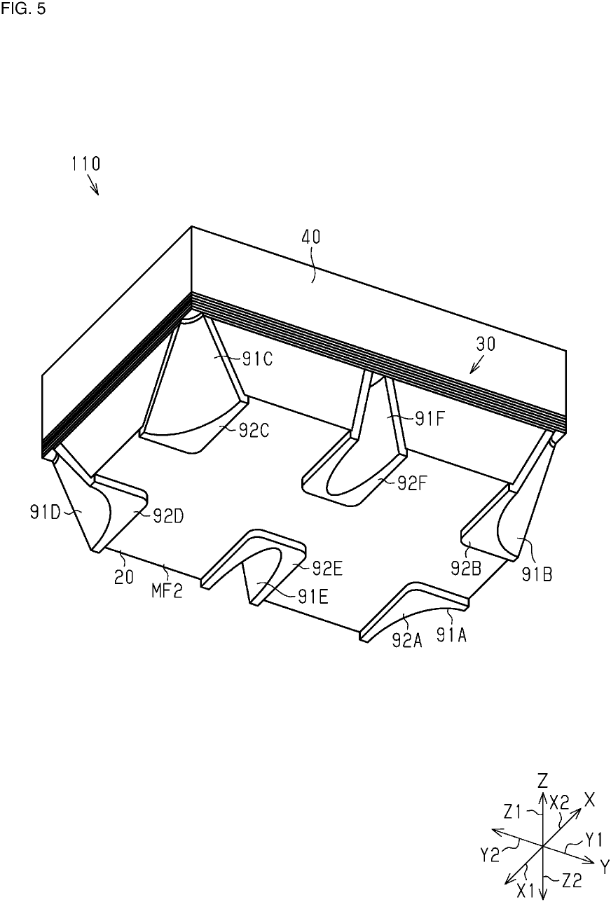

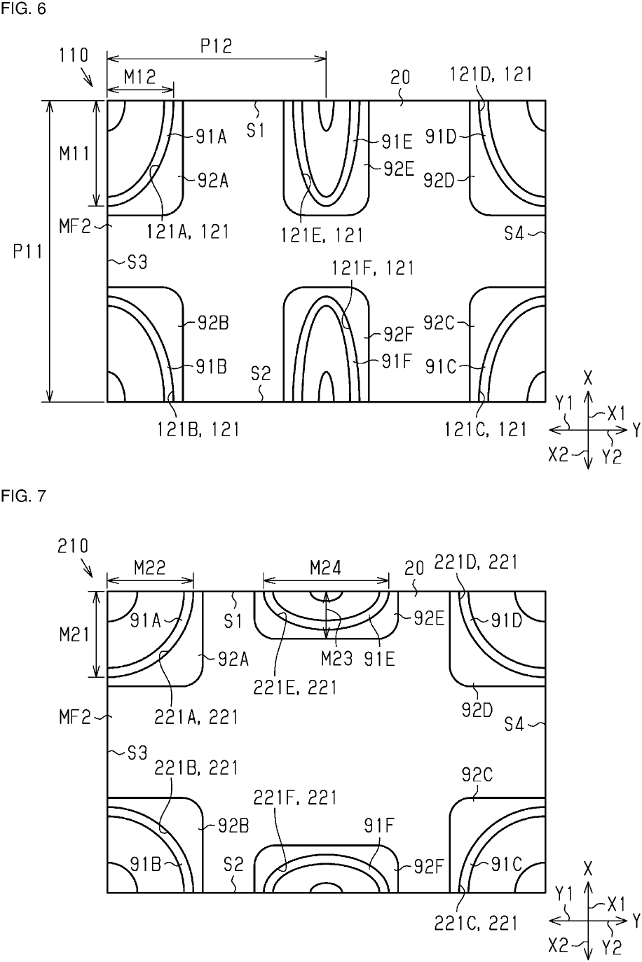

As depicted in FIG. 5, the electronic component 110 includes six outer electrodes 92A to 92F and six connecting portions 91A to 91F. This is because, although details are omitted, the electronic component 110 includes three coils. Although not depicted in the drawings, each coil extends inside the multilayer body 30. Also, part of extended wirings connected to both ends of each coil connects to each of connecting portions 91A to 91F. Also, as depicted in FIG. 6, six cutouts 121 are positioned on positions corresponding to the connecting portions 91A to 91F, respectively.

### Regarding Cutout

As depicted in FIG. 6, the first magnetic substrate 20 includes six cutouts 121A to 121F. When the first magnetic substrate 20 is viewed toward the third positive direction Z1, the cutouts 121 are present at four corners and midpoints of long sides, respectively. Note that the six cutouts 121A to 121F are referred to below as cutouts 121 when a distinction is not made among them.

The cutout 121A is positioned at a corner on a first positive direction X1 side and a second positive direction Y1 side when viewed from the center of the first magnetic substrate 20. The cutout 121B is positioned at a corner on a first negative direction X2 side and a second positive direction Y1 side when viewed from the center of the first magnetic substrate 20. The cutout 121C is positioned at a corner on a first negative direction X2 side and a second negative direction Y2 side when viewed from the center of the first magnetic substrate 20. The cutout 121D is positioned at a corner on a first positive direction X1 side and a second negative direction Y2 side when viewed from the center of the first magnetic substrate 20.

The cutout 121E is positioned at the center of the side S1 in a direction along the second axis Y when the first magnetic substrate 20 is viewed toward the third positive direction Z1. Thus, the cutout 121E is present only on the side S1 and is recessed inward from the side S1. That is, the cutout 121E is recessed from the side S1 to a first negative direction X2 side.

The cutout 121F is positioned at the center of the side S2 in a direction along the second axis Y when the first magnetic substrate 20 is viewed toward the third positive direction Z1. Thus, the cutout 121F is present only on the side S2 and is recessed inward from the side S2. That is, the cutout 121F is recessed from the side S2 to a first positive direction X1 side.

Also, when the first magnetic substrate 20 is viewed toward the third positive direction Z1, a maximum dimension of the cutout 121A in a direction perpendicular to the side S1, that is, a direction along the first axis X, is taken as a first dimension M11. Also, when the first magnetic substrate 20 is viewed toward the third positive direction Z1, a maximum dimension of the cutout 121A in a direction along the side S1, that is, a direction along the second axis Y, is taken as a second dimension M12. Here, the first dimension M11 is different from the second dimension M12. Specifically, the first dimension M11 is larger than the second dimension M12. In this case, when the side S3 is taken as a first side, a first direction is the direction along the first axis X, a second side is the side S1, and a second direction is the direction along the second axis Y.

When the first magnetic substrate 20 is viewed toward the third positive direction Z1, a maximum dimension of the cutout 121B in a direction along the side S3, that is, the direction along the first axis X, is larger than a maximum dimension of the cutout 121B in a direction perpendicular to the direction along the side S3, that is, the direction along the second axis Y.

When the first magnetic substrate 20 is viewed toward the third positive direction Z1, a maximum dimension of the cutout 121C in a direction along the side S3, that is, the direction along the first axis X, is larger than a maximum dimension of the cutout 121C in a direction perpendicular to the direction along the side S3, that is, the direction along the second axis Y.

When the first magnetic substrate 20 is viewed toward the third positive direction Z1, a maximum dimension of the cutout 121D in a direction along the side S3, that is, the direction along the first axis X, is larger than a maximum dimension of the cutout 121D in a direction perpendicular to the direction along the side S3, that is, the direction along the second axis Y.

When the first magnetic substrate 20 is viewed toward the third positive direction Z1, a maximum dimension of the cutout 121E in a direction along the side S3, that is, the direction along the first axis X, is larger than a maximum dimension of the cutout 121E in a direction perpendicular to the direction along the side S3, that is, the direction along the second axis Y.

When the first magnetic substrate 20 is viewed toward the third positive direction Z1, a maximum dimension of the cutout 121F in a direction along the side S3, that is, the direction along the first axis X, is larger than a maximum dimension of the cutout 121F in a direction perpendicular to the direction along the side S3, that is, the direction along the second axis Y.

The cutout 121E and the cutout 121F each have a half shape obtained by cutting out an oval into halves along the minor axis.

When the first magnetic substrate 20 is viewed toward the third positive direction Z1, the second dimension M12 is equal to a maximum dimension of each of the cutouts 121B to 121F in the direction along the second axis Y. Also, when the first magnetic substrate 20 is viewed toward the third positive direction Z1, the first dimension M11 is equal to a maximum dimension of each of the cutouts 121B to 121F in the direction along the first axis X. Thus, when the first magnetic substrate 20 is viewed toward the third positive direction Z1, all of the cutouts 121 have an equal area.

Also, on the side S1, three cutouts, that is, the cutout 121A, the cutout 121D, and the cutout 121E are present. On the side S3, two cutouts, that is, the cutout 121A and the cutout 121B are present.

Here, when the first magnetic substrate 20 is viewed toward the third positive direction Z1, the first magnetic substrate 20 has a rectangular shape elongated to a direction along the second axis Y as a whole. Thus, the dimension of the first magnetic substrate 20 in a direction along the side S1 is larger than the dimension of the first magnetic substrate 20 in a direction along the side S3. The dimension of the first magnetic substrate 20 in the direction along the side S1 is the maximum dimension of the first magnetic substrate 20 in the direction along the second axis Y. Also, the dimension of the first magnetic substrate 20 in a direction along the side S3 is the maximum dimension of the first magnetic substrate 20 in the direction along the first axis X. Also, a value obtained by dividing the dimension of the first magnetic substrate 20 in the direction along the side S3 by a number obtained by subtracting 1 from the number of cutouts 121 present on the side S3, that is, 2, is taken as a first side pitch P11. Also, a value obtained by dividing the dimension of the first magnetic substrate 20 in the direction along the side S1 by a number obtained by subtracting 1 from the number of cutouts 121 present on the side S1, that is, 3, is taken as a second side pitch P12. In this case, the first side pitch P11 is larger than the second side pitch P12. That is, the pitch between the cutouts 121 present on the side S3 is larger than the pitch between the cutouts 121 present on the side S1.

### Regarding Effect of Embodiment 2

According to Embodiment 2 described above, in addition to the effects of Embodiment 1 described in (1-1), (1-2), (1-4), and (1-5), the following effect is exerted.

(2-1) According to Embodiment 2 described above, when the first magnetic substrate 20 is viewed toward the third positive direction Z1, the cutout 121E is positioned at the center of the side S 1 in the direction along the second axis Y. When the first magnetic substrate 20 is viewed toward the third positive direction Z1, the cutout 121F is positioned at the center of the side S2 in the direction along the second axis Y. In this case, irrespective of the dimensions of the first magnetic substrate 20 in the direction along the first axis X and in the direction along the second axis Y, the dimension of each cutout 121 in a long direction can be designed based on the pitch between the cutouts 121 present on the side S1 and the pitch between the cutouts 121 present on the side S3.

### Embodiment 3

Embodiment 3 of the electronic component is described below with reference to the drawings. An electronic component 210 of Embodiment 3 is different from the electronic component 110 of Embodiment 2 mainly in the shape of each cutout 221. Note that description is made below mainly on points different from the electronic component 110 in Embodiment 2 and description on the same points is simplified or omitted.

### Regarding Cutout

As depicted in FIG. 7, the first magnetic substrate 20 includes six cutouts 221A to 221F. When the first magnetic substrate 20 is viewed toward the third positive direction Z1, the cutouts 221 are present at four corners and midpoints of long sides, respectively. The position of each cutout 221 is identical to the position of each cutout 121 in Embodiment 2. Note that the six cutouts 221A to 221F are referred to below as cutouts 221 when a distinction is not made among them.

The cutouts 221A to 221D are present at four corners when the first magnetic substrate 20 is viewed toward the third positive direction Z1. The cutouts 221A to 221D have a shape cutting a perfect circle into four pieces in a circumferential direction.

When the first magnetic substrate 20 is viewed toward the third positive direction Z1, a maximum dimension of the cutout 221A in a direction perpendicular to a direction along the side S1, that is, a direction along the first axis X, is taken as a first dimension M21. Also, when the first magnetic substrate 20 is viewed toward the third positive direction Z1, a maximum dimension of the cutout 221A in a direction along the side S1, that is, a direction along the second axis Y, is taken as a second dimension M22. Here, the first dimension M21 is equal to the second dimension M22. Also, the cutout 221A is an end cutout positioned at an end of the side S1 and an end of the side S3.

When the first magnetic substrate 20 is viewed toward the third positive direction Z1, a maximum dimension of the cutout 221B in a direction along the side S1, that is, a direction along the second axis Y, is equal to a maximum dimension of the cutout 221B in a direction perpendicular to the direction along the side S1, that is, a direction along the first axis X. Also, the cutout 221B is an end cutout positioned at an end of the side S2 and an end of the side S3.

When the first magnetic substrate 20 is viewed toward the third positive direction Z1, a maximum dimension of the cutout 221C in a direction along the side S1, that is, a direction along the second axis Y, is equal to a maximum dimension of the cutout 221C in a direction perpendicular to the direction along the side S1, that is, a direction along the first axis X. Also, the cutout 221C is an end cutout positioned at an end of the side S2 and an end of the side S4.

When the first magnetic substrate 20 is viewed toward the third positive direction Z1, a maximum dimension of the cutout 221D in a direction along the side S1, that is, a direction along the second axis Y, is equal to a maximum dimension of the cutout 221D in a direction perpendicular to the direction along the side S1, that is, a direction along the first axis X. Also, the cutout 221D is an end cutout positioned at an end of the side S1 and an end of the side S4.

When the first magnetic substrate 20 is viewed toward the third positive direction Z1, a maximum dimension of the cutout 221E in a direction perpendicular to a direction along the side S1, that is, a direction along the first axis X, is taken as a third dimension M23. Also, when the first magnetic substrate 20 is viewed toward the third positive direction Z1, a maximum dimension of the cutout 221E in a direction along the side S1, that is, a direction along the second axis Y, is taken as a fourth dimension M24. Here, the third dimension M23 is smaller than the fourth dimension M24. Also, the cutout 221E is a middle cutout positioned partway on the side S1.

When the first magnetic substrate 20 is viewed toward the third positive direction Z1, the maximum dimension of the cutout 221F in a direction perpendicular to a direction along the side S1, that is, a direction along the first axis X, is smaller than the maximum dimension of the cutout 221F in a direction along the side S1, that is, a direction along the second axis Y. Also, the cutout 221F is a middle cutout positioned partway on the side S2. When the first magnetic substrate 20 is viewed toward the third positive direction Z1, the third dimension M23 is equal to the maximum dimension of the cutout 221F in a direction perpendicular to a direction along the side S1, that is, a direction along the first axis X. When the first magnetic substrate 20 is viewed toward the third positive direction Z1, the fourth dimension M24 is equal to the maximum dimension of the cutout 221F in a direction along the side S1, that is, a direction along the second axis Y

### Regarding Operation and Effects of Embodiment 3

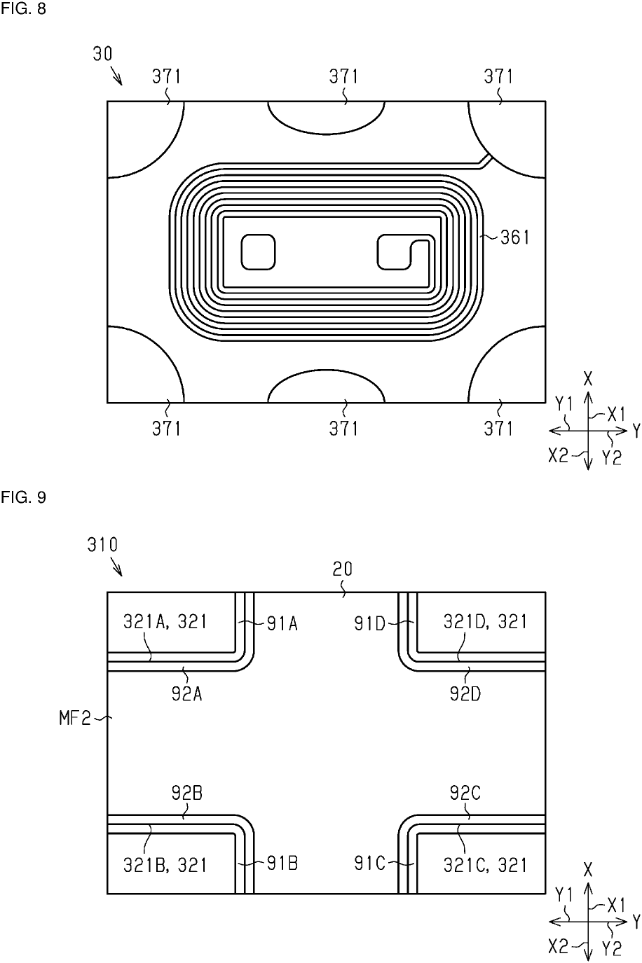

As depicted in FIG. 8, when the multilayer body 30 is viewed toward the third positive direction Z1, a coil 361 extends inside the multilayer body 30. Here, since extended portions 371 are provided at locations corresponding to the cutouts 221 of the multilayer body 30, a range of winding the coil 361 is restricted. In this respect, if the dimension of the cutout 221E as a middle cutout in a direction along the first axis X is excessively large, when the multilayer body 30 is viewed toward the third positive direction Z1, a range where the cutout 221E and the coil 361 overlap is increased. As a result, the range of winding the coil 361 is decreased.

### Regarding Effect of Embodiment 3

According to Embodiment 3 described above, in addition to the effects of Embodiment 1 described in (1-1), the following effect is exerted.

(3-1) According to Embodiment 3 described above, when the first magnetic substrate 20 is viewed toward the third positive direction Z1, a distance between the coil 361 and the cutouts 221E and 221F, which are middle cutouts, can be increased. Also, when the first magnetic substrate 20 is viewed toward the third positive direction Z1, the overlapping range of the coil 361 and the middle cutouts can be decreased. Therefore, electrical interference between the extended portion 371 provided to the cutout 221 and the coil 361 can be suppressed.

### Other Embodiments

Each of the above-described embodiments can be implemented as modified as follows. Each of the above-described embodiments and modifications below can be implemented as combined in a technologically non-contradictive range.

When the first magnetic substrate 20 is viewed toward the third positive direction Z1, the first magnetic substrate 20 may have a square shape. That is, the maximum dimension of the first magnetic substrate 20 in a direction along the first axis X may be equal to the maximum dimension of the first magnetic substrate 20 in a direction along the second axis Y.

The shape of each cutout of the first magnetic substrate 20 is not limited to that in the example of each of the above-described embodiments. For example, an electronic component 310 of a modification depicted in FIG. 9 is different from the electronic component 10 of Embodiment 1 in the shape of each cutout 321. Specifically, when the first magnetic substrate 20 is viewed toward the third positive direction Z1, the cutouts 321A to 321D each have a rectangular shape. An electronic component 410 of a modification depicted in FIG. 10 is different from the electronic component 10 of Embodiment 1 in the shape of each cutout 421. Specifically, when the first magnetic substrate 20 is viewed toward the third positive direction Z1, the cutouts 421A to 421D each have a triangular shape.

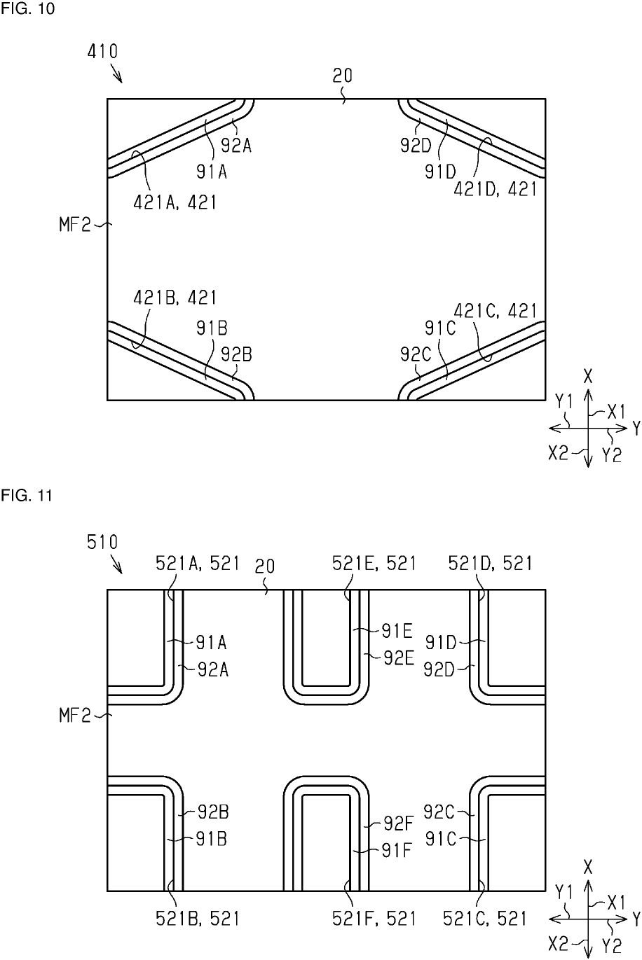

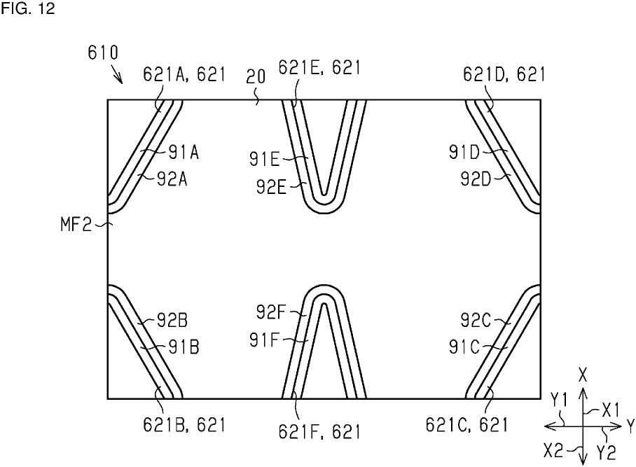

Also, an electronic component 510 of a modification depicted in FIG. 11 is different from the electronic component 110 of Embodiment 2 in the shape of each cutout 521. Specifically, when the first magnetic substrate 20 is viewed toward the third positive direction Z1, the cutouts 521A to 521F each have a rectangular shape. An electronic component 610 of a modification depicted in FIG. 12 is different from the electronic component 110 of Embodiment 2 in the shape of each cutout 621. Specifically, when the first magnetic substrate 20 is viewed toward the third positive direction Z1, the cutouts 621A to 621F each have a triangular shape. Thus, the shape of a cutout can be changed as appropriate. Furthermore, part of the plurality of cutouts may be different in shape, compared with the other cutouts.

In each of the above-described embodiments, when the first magnetic substrate 20 is viewed toward the third positive direction Z1, each cutout may have a different area. For example, the area of each cutout may be changed as appropriate in accordance with the position of the cutout.

In each of the above-described embodiments, it is only required that the maximum dimension of each cutout in a direction along the first axis X and the maximum dimension thereof in a direction along the second axis Y are different from each other. For example, in Embodiment 1, the first dimension M1 may be larger than the second dimension M2.

In Embodiment 2 described above, when N and M are natural numbers larger than or equal to 2, it is assumed that N cutouts 121 are present on the side S3 as the first side and M cutouts 121 are present on the side S1 as the second side. It is also assumed that a value obtained by dividing the dimension of the first magnetic substrate 20 in a direction along the side S3 by N-1 is larger than a value obtained by dividing the dimension of the first magnetic substrate 20 in a direction along the side S1 by M-1. In this case, the first dimension M11 is preferably larger than the second dimension M12. According to this, as with Embodiment 2, since the dimension of the cutout 121 in the extending direction of the small-pitch side S1 can be relatively small, the distance between the cutouts 121 in the direction along the side S1 is easily ensured.

In each of the above-described embodiments, irrespective of the pitch of the cutouts on the first side and the pitch of the cutouts on the second side, the maximum dimension of the cutout in a direction along the first axis X may be different from the maximum dimension of the cutout in a direction along the second axis Y. For example, in Embodiment 2, the dimension of the cutout 121 in the direction along the side S3 may be smaller than the dimension of the cutout 121 in the direction along the side S1.

In Embodiment 1 described above, the inter-cutout distance D1 may be different from the inter-cutout distance D2. For example, as long as a large area of the second main surface MF2 of the first magnetic substrate 20 can be ensured as a whole, even if the inter-cutout distance D1 or the inter-cutout distance D2 is small, the tilt of the orientation of the electronic component 10 when mounted on a substrate can be suppressed.

The structure of the multilayer body 30 may be changed as appropriate. For example, in Embodiment 1, the structure may be changed in accordance with the way of extension of the first coil 61 and its number, the way of extension of the first extended wiring 70A, and so forth. It is only required that the multilayer body 30 is formed of at least a plurality of insulator layers.

The second magnetic substrate 40 may be omitted, and may be a resin containing magnetic powder, instead of a sintered body.

The first adhesive layer 51 and the second adhesive layer 52 may be omitted. In this case, the first magnetic substrate 20 and the multilayer body 30, and the second magnetic substrate 40 and the multilayer body 30 may be connected by pressure bonding or the like.

Each connecting portion 91 may cover the entire portion, exposed outside the multilayer body 30, of an extended wiring. For example, in the electronic components of modifications depicted in FIG. 9 to FIG. 12, each connecting portion 91 covers the entire surface of the extended portion oriented to the third negative direction Z2.

What is claimed is:

1. An electronic component comprising:
a magnetic substrate having a first main surface and a second main surface parallel to the first main surface, the magnetic substrate having a plurality of cutouts having an inner surface connecting the first main surface and the second main surface together;
a multilayer body including a plurality of insulator layers laminated on the first main surface;
a plurality of coils extending inside the multilayer body;
an extended wiring connecting to an end of the coils and partially exposed inside of the cutouts;
a connecting portion which is present on the inner surface of the cutout and connects to the extended wiring; and
an outer electrode which is present on the second main surface and connects to the connecting portion, wherein
when the magnetic substrate is viewed toward a direction perpendicular to the first main surface, an outer edge of the magnetic substrate includes a first side which is linear, and at least one of the plurality of cutouts is recessed inward from the first side, and
when the magnetic substrate is viewed toward the direction perpendicular to the first main surface and when a direction along the first side is defined as a first direction and a direction perpendicular to the first direction is defined as a second direction, a maximum dimension of the cutout in the first direction is different from a maximum dimension of the cutout in the second direction.

2. The electronic component according to claim 1, wherein
when the magnetic substrate is viewed toward the direction perpendicular to the first main surface, the outer edge of the magnetic substrate includes a second side adjacent to the first side and along the second direction,
when N and M are natural numbers larger than or equal to 2,
N cutouts are present on the first side and M cutouts are present on the second side, and
a value obtained by dividing a maximum dimension of the magnetic substrate in the first direction by N-1 is larger than a value obtained by dividing a maximum dimension of the magnetic substrate in the second direction by M-1, and
the maximum dimension of the cutout in the first direction is larger than the maximum dimension of the cutout in the second direction.

3. The electronic component according to claim 1, wherein
a maximum dimension of the magnetic substrate in the first direction is larger than a maximum dimension of the magnetic substrate in the second direction,
when the magnetic substrate is viewed toward the direction perpendicular to the first main surface, the outer edge of the magnetic substrate includes a second side adjacent to the first side and along the second direction,
a plurality of the cutouts is present on the first side and a same number of the cutouts are present on the second side as the number of the cutouts on the first side, and
when a shortest distance between adjacent two of the cutouts is defined as an inter-cutout distance, the inter-cutout distance in the first direction is equal to the inter-cutout distance in the second direction.

4. The electronic component according to claim 1, wherein
the plurality of cutouts has end cutouts located at ends of the first side and a middle cutout located partway on the first side, and
when the magnetic substrate is viewed toward the direction perpendicular to the first main surface, a maximum dimension of the middle cutout in the second direction is smaller than a maximum dimension of the middle cutout present on the first side in the first direction.

5. The electronic component according to claim 1, wherein
when the magnetic substrate is viewed toward the direction perpendicular to the first main surface, all of the cutouts have an equal area.

6. The electronic component according to claim 1, wherein
when the magnetic substrate is viewed toward the direction perpendicular to the first main surface, each of the cutouts has a shape obtained by partially cutting out an oval.

7. The electronic component according to claim 2, wherein
a maximum dimension of the magnetic substrate in the first direction is larger than a maximum dimension of the magnetic substrate in the second direction,
when the magnetic substrate is viewed toward the direction perpendicular to the first main surface, the outer edge of the magnetic substrate includes a second side adjacent to the first side and along the second direction,
a plurality of the cutouts is present on the first side and a same number of the cutouts are present on the second side as the number of the cutouts on the first side, and
when a shortest distance between adjacent two of the cutouts is defined as an inter-cutout distance, the inter-cutout distance in the first direction is equal to the inter-cutout distance in the second direction.

8. The electronic component according to claim 2, wherein
the plurality of cutouts has end cutouts located at ends of the first side and a middle cutout located partway on the first side, and
when the magnetic substrate is viewed toward the direction perpendicular to the first main surface, a maximum dimension of the middle cutout in the second direction is smaller than a maximum dimension of the middle cutout present on the first side in the first direction.

9. The electronic component according to claim 3, wherein
the plurality of cutouts has end cutouts located at ends of the first side and a middle cutout located partway on the first side, and
when the magnetic substrate is viewed toward the direction perpendicular to the first main surface, a maximum dimension of the middle cutout in the second direction is smaller than a maximum dimension of the middle cutout present on the first side in the first direction.

10. The electronic component according to claim 7, wherein
the plurality of cutouts has end cutouts located at ends of the first side and a middle cutout located partway on the first side, and
when the magnetic substrate is viewed toward the direction perpendicular to the first main surface, a maximum dimension of the middle cutout in the second direction is smaller than a maximum dimension of the middle cutout present on the first side in the first direction.

11. The electronic component according to claim 2, wherein
when the magnetic substrate is viewed toward the direction perpendicular to the first main surface, all of the cutouts have an equal area.

12. The electronic component according to claim 3, wherein
when the magnetic substrate is viewed toward the direction perpendicular to the first main surface, all of the cutouts have an equal area.

13. The electronic component according to claim 4, wherein
when the magnetic substrate is viewed toward the direction perpendicular to the first main surface, all of the cutouts have an equal area.

14. The electronic component according to claim 7, wherein
when the magnetic substrate is viewed toward the direction perpendicular to the first main surface, all of the cutouts have an equal area.

15. The electronic component according to claim 8, wherein
when the magnetic substrate is viewed toward the direction perpendicular to the first main surface, all of the cutouts have an equal area.

16. The electronic component according to claim 2, wherein
when the magnetic substrate is viewed toward the direction perpendicular to the first main surface, each of the cutouts has a shape obtained by partially cutting out an oval.

17. The electronic component according to claim 3, wherein
when the magnetic substrate is viewed toward the direction perpendicular to the first main surface, each of the cutouts has a shape obtained by partially cutting out an oval.

18. The electronic component according to claim 4, wherein
when the magnetic substrate is viewed toward the direction perpendicular to the first main surface, each of the cutouts has a shape obtained by partially cutting out an oval.

19. The electronic component according to claim 5, wherein
when the magnetic substrate is viewed toward the direction perpendicular to the first main surface, each of the cutouts has a shape obtained by partially cutting out an oval.

20. The electronic component according to claim 7, wherein
when the magnetic substrate is viewed toward the direction perpendicular to the first main surface, each of the cutouts has a shape obtained by partially cutting out an oval.
